(19) United States
(12) Patent Application Publication
(10) Pub. No.: US 2025/0078541 A1
(43) Pub. Date: Mar. 6, 2025

(54) METHOD FOR DETECTING INFRARED SHIP TARGET BASED ON IMPROVED YOLOV7

(71) Applicant: YANGTZE UNIVERSITY, Jingzhou (CN)

(72) Inventors: Xiang’e SUN, Jingzhou (CN); Weiwei GONG, Jingzhou (CN); Gongming ZHENG, Jingzhou (CN); Lin HU, Jingzhou (CN); Meihua LIU, Jingzhou (CN)

(21) Appl. No.: 18/521,483

(22) Filed: Nov. 28, 2023

(30) Foreign Application Priority Data
Sep. 5, 2023 (CN) 202311142979.1

(51) Int. Cl. G06V 20/64; G06V 10/776; G06V 10/82

(52) U.S. Cl. CPC G06V 20/64; G06V 10/776; G06V 10/82; G06V 2201/07

(57) ABSTRACT

A method for detecting an infrared ship target based on an improved YOLOv7 is provided, including the following steps: obtaining an infrared maritime ship data set; reforming a YOLOv7 network structure based on an MobileNetv3 network and a bidirectional weighted feature pyramid network, and obtaining an infrared ship target detection model by introducing an attention mechanism and an optimized loss function; training and verifying the infrared ship target detection model based on the infrared maritime ship data set to obtain the infrared ship target detection model trained; and detecting a maritime ship based on the infrared ship target detection model trained.

### CROSS-REFERENCE TO RELATED APPLICATIONS

This application claims priority to Chinese Patent Application No. 202311142979.1, filed on Sep. 5, 2023, the contents of which are hereby incorporated by reference.

### TECHNICAL FIELD

The application belongs to the technical field of infrared image ship target detection, and in particular to a method for detecting an infrared ship target based on an improved YOLOv7.

### BACKGROUND

With the rapid development of unmanned surface vehicles (USVs) and intelligent industry, the number and types of maritime ships are increasing, which poses a threat to navigation safety. Therefore, it is of great significance to realize accurate detection of ship targets. However, using ship radar to detect ship targets, on the one hand, may not fully obtain the target attributes, for example, using ship radar to detect ship targets may not determine whether the target on the ship radar is a ship; on the other hand, in the dark environment with insufficient light, the visible light detection method cannot detect the ship target. In contrast, infrared (IR) sensor detection system has unique advantages in detecting ship targets through smoke, dust and fog, and may realize continuous passive detection day and night. Therefore, infrared detection system has important military and civil applications, such as ship collision avoidance, navigation safety, ship traffic management and so on.

In recent years, with the development of deep learning theory and algorithm, the accuracy and speed of target detection algorithm have been improved. Some target detection algorithms based on deep learning have also been applied to ship detection, but most of the current ship target detection algorithms tend to increase model parameters or add additional network components to improve the accuracy of target detection. However, the embedded device carried by ship detection has limited computing power, and the real-time performance of target detection on embedded device is poor for networks with complex calculations and large parameters. Therefore, it is of great practical significance to lighten the target detection model to meet the requirements of real-time detection of maritime ships.

### SUMMARY

The objective of the present application is to provide a method for detecting an infrared ship target based on an improved YOLOv7 (You Only Look Once version 7), so as to solve the problems existing in the prior art.

In order to achieve the above objective, the application provides a method for detecting an infrared ship target based on an improved YOLOv7, including the following steps:
obtaining an infrared maritime ship data set;
reforming a YOLOv7 network structure based on an MobileNetv3 network and a bidirectional weighted feature pyramid network, and obtaining an infrared ship target detection model by introducing an attention mechanism and an optimized loss function;
training and verifying the infrared ship target detection model based on the infrared maritime ship data set to obtain the infrared ship target detection model trained; and
detecting a maritime ship based on the infrared ship target detection model trained.

Optionally, after obtaining the infrared maritime ship data set, further including: carrying out a data enhancement processing on the infrared maritime ship data set, and then dividing the infrared maritime ship data set processed into a training set, a verification set and a test set based on a preset ratio.

Optionally, a process of reforming the YOLOv7 network structure based on the MobileNetv3 network and the bidirectional weighted feature pyramid network includes: replacing a backbone feature extraction network in the YOLOv7 network structure with the MobileNetv3 network, and replacing a feature fusion network in the YOLOv7 network structure with the bidirectional weighted feature pyramid network.

Optionally, the MobileNetv3 network combines a depthwise separable convolution structure and an inverted residual structure, and is integrated into a channel attention mechanism network; where, the depthwise separable convolution structure includes a depthwise convolution and a pointwise convolution.

Optionally, the bidirectional weighted feature pyramid network increases a feature image weight, introduces a residual strategy, deletes nodes with low contribution, and adds an intermediate feature channel.

Optionally, a process of increasing the feature image weight includes: the bidirectional weighted feature pyramid network automatically learns weight parameters of each input feature layer, and then performs a weighted feature fusion on the input feature layer with different resolutions and corresponding weight parameters and performs an output; where the bidirectional weighted feature pyramid network adds a jump connection between the input feature layer and an output feature layer in a same layer.

Optionally, calculation formulas of the weighted feature fusion is as follows:

$${P}_{i}^{td} = Conv ( \frac{{w}_{1} \cdot {P}_{i}^{in} + {w}_{2} \cdot {P}_{i + 1}^{in}}{{w}_{1} + {w}_{2} + ϵ} )$$

$${P}_{i}^{out} = Conv ( \frac{{{w}_{1}}^{′} \cdot {P}_{i}^{in} + {{w}_{2}}^{′} \cdot {P}_{i}^{td} + {{w}_{3}}^{′} \cdot {P}_{i - 1}^{out}}{{{w}_{1}}^{′} + {{w}_{2}}^{′} + {{w}_{3}}^{′} + ϵ} )$$

where Pᵢ^{td} and Pᵢ^{out} represent intermediate transition features of an i-layer on a top-down path and final output features of an i-layer on a down-top path; w₁ and w₂ respectively represent the weight parameters for calculating an input of a current layer and an input of a next layer of the intermediate transition features; w₁′, w₂′ and w₃′ respectively represent a weight of the input of the current layer, a weight of an output of a transition unit of the current layer and a weight of an output of a previous layer, ∈ value is 0.0001, and Conv stands for a convolution operation on a whole calculation result.

Optionally, the attention mechanism is an SENet (Squeeze-and-Excitation Networks) structure with a soft attention mechanism, and the SENet structure is used to extract importance degree of each feature channel by an active learning method, then give the each feature channel different weights, and finally perform a filtration processing for features in a detection task based on a weight of the each feature channel.

Optionally, the optimized loss function is shown in following formulas:

$${ℒ}_{WIoUv 3} = r {ℒ}_{WIoUv 1} , r = \frac{β}{{δα}^{β - δ}}$$

$${ℒ}_{WIoUv 1} = {R}_{WIoU} {ℒ}_{IoU} , β = \frac{{ℒ}_{IoU}^{*}}{\overline{{ℒ}_{IoU}}} ∈ [ 0 , + ∞ )$$

$${R}_{WIoU} = exp ( \frac{{( x - {x}_{gt} )}^{2} + {( y - {y}_{gt} )}^{2}}{{( {W}_{g}^{2} + {H}_{g}^{2} )}^{*}} )$$

where β is an outlier degree to describe a quality of an anchor frame; r is a nonmonotonic focusing coefficient, α and δ are hyperparameters; R_{WIoU} is a penalty term of a loss function; [symbol] _{IoU} is an overlap loss between a prediction frame and the anchor frame; (x,y) are center coordinates of the prediction frame, and (x_{gt}, y_{gt}) are center coordinates of a real frame; (W_{g}, H_{g}) are a width and a height of a minimum bounding rectangle of the real frame and the prediction frame; and * represents separating (W_{g}, H_{g}) from a current calculation diagram.

Optionally, a process of training and verifying the infrared ship target detection model includes: setting an initial learning rate and initial iterations of the infrared ship target detection model, and adaptively adjusting a scaling of the training set, verification set and test set based on a preset input image size; cross-verifying an average accuracy change and loss change trend of the infrared ship target detection model based on the training set and the verification set after an adjusting, and adjusting the initial learning rate and the initial iterations until the average accuracy change and loss change tend to be stable, so as to obtain a target learning rate and target iterations, and further obtain the infrared ship target detection model trained; finally, testing the infrared ship target detection model trained based on the test set after the adjusting.

The application has the following technical effects.

The application provides a method for detecting an infrared ship target based on an improved YOLOv7, which takes the latest method YOLOv7 as a benchmark, uses a lightweight network MobileNet-V3 as a feature extraction network in the YOLOv7 network structure in the model construction stage, and carries out lightweight reform on the model to reduce the model parameter amount; bidirectional weighted feature pyramid architecture is adopted in the feature fusion stage to realize multi-scale feature fusion more efficiently and quickly; meanwhile, attention mechanism is introduced to suppress useless information and improve the accuracy of the model; the Wise-IoU loss function is introduced in the detecting stage to accelerate the network convergence, which may meet the requirements of real-time detection of ship targets and may detect ships efficiently and accurately in real time. The application improves four aspects of the model, which cooperate with each other to form a more advanced and efficient target detection network structure, and jointly improve the efficiency and accuracy of target detection.

Through the above-mentioned reform of the model, the application greatly reduces the parameter amount and calculation amount of the model, has higher confidence and detection speed, occupies small memory, has high precision and speed, is easy to deploy on a platform with micro-computing power and low power consumption, and may meet the requirements of practical application.

### BRIEF DESCRIPTION OF THE DRAWINGS

The drawings, which constitute a part of this application, are used to provide a further understanding of this application. The illustrative embodiments of this application and the descriptions are used to explain this application, and do not constitute an improper limitation of this application.

FIG. 1 is a flowchart of a method for detecting an infrared ship target based on an improved YOLOv7 in the embodiment of the present application.

FIG. 2 is a schematic diagram of the improved YOLOv7 network structure in the embodiment of the present application.

FIG. 3 is a schematic diagram of the backbone network structure in the embodiment of the present application.

FIG. 4 is a schematic diagram of a feature pyramid structure in the embodiment of the present application.

FIG. 5 is a schematic diagram of the attention mechanism structure in the embodiment of the present application.

FIG. 6 is a flowchart of a method for real-time detection of ships in an embodiment of the present application.

### DETAILED DESCRIPTION OF THE EMBODIMENTS

It should be noted that the embodiments in this application and the features in the embodiments may be combined with each other without conflict. The present application will be described in detail with reference to the attached drawings and embodiments.

It should be noted that the steps shown in the flowchart of the attached drawings may be executed in a computer system such as a set of computer-executable instructions, and although the logical order is shown in the flowchart, in some cases, the steps shown or described may be executed in a different order from here.

### Embodiment 1

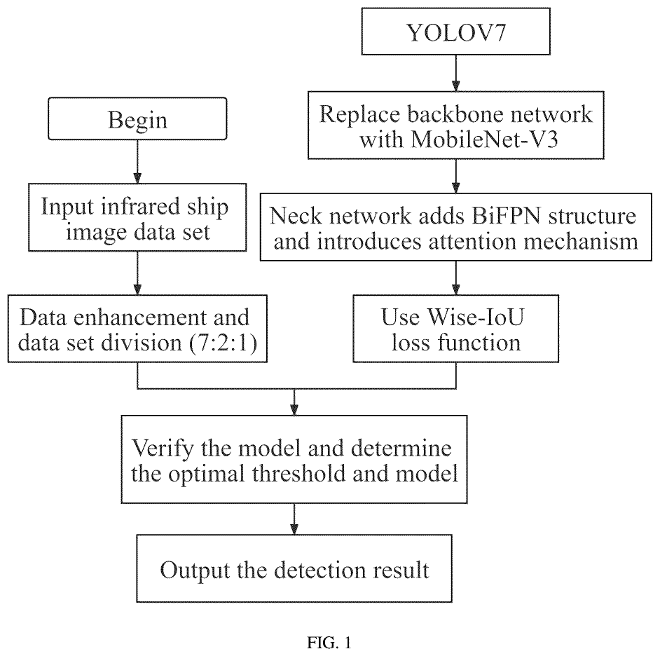

As shown in FIG. 1, this embodiment provides an overall flow diagram of a method for detecting an infrared ship target based on an improved YOLOv7, which specifically includes:

S1, constructing an infrared ship detection training set, a verification set and a test set, randomly making a division according to the ratio of 7:2:1, converting the divided data set in Visual Object Classes (VOC) format into a data set in YOLO (You Only Look Once) format, and carrying out the data enhancement preprocessing on the infrared marine ship data set, such as left-right flipping, image zooming and Mosaic image enhancement.

Further, Mosaic image enhancement randomly cuts a selected image and three random images, then splicing them into an image, which is sent to the network for training, thus improving the universality and robustness of the network.

S2, constructing an infrared ship target detection model based on the improved YOLOv7.

S3, model training and verifying: training the YOLOv7 model improved by S2, optimizing the network parameters to obtain the weight file for detection, and performing verifying.

S4, model test: sending the test set to the model trained in S3 to test the performance of infrared image ship target detection model based on improved YOLOv7.

S5, model evaluation: according to the test results of S4, evaluating the infrared ship target detection model based on improved YOLOv7 trained by S3 with mAP and FPS as evaluation indexes.

S6, using the infrared ship target detection model based on the improved YOLOv7 trained in S3 to detect ship targets in infrared images or infrared video streams.

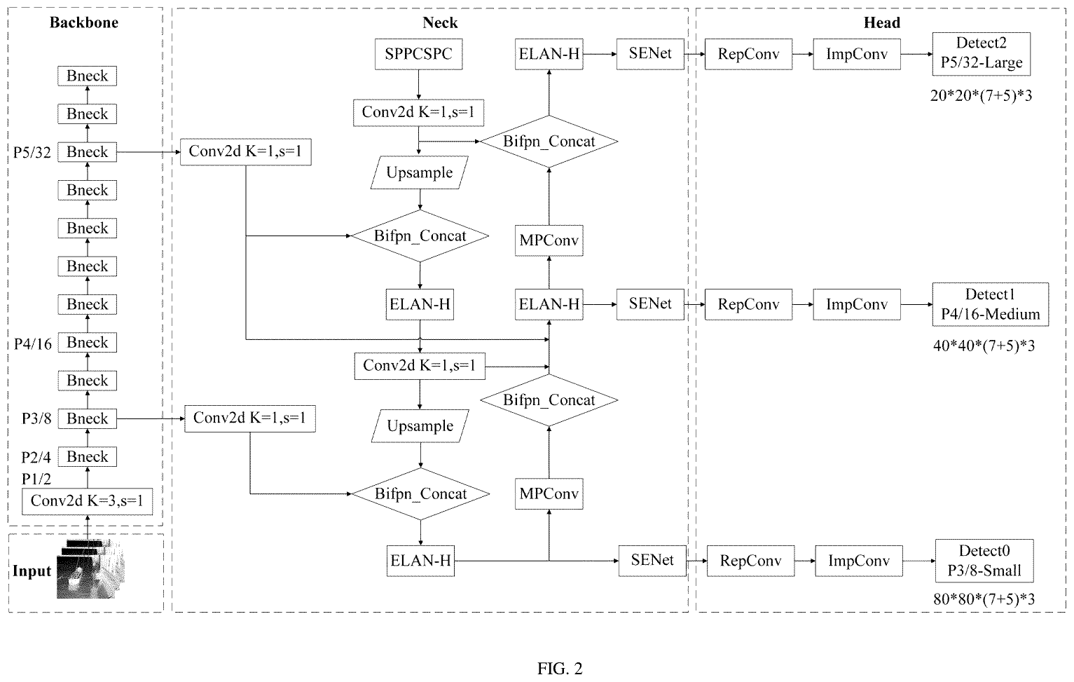

The network structure diagram of the infrared ship target detection model in this embodiment is shown in FIG. 2. Ship target detection algorithm not only needs to accurately identify sea targets in various marine environments, but also needs to reduce the model size as much as possible to complete real-time target detection on the embedded platform. In this embodiment, based on the detection principle of YOLOv7 algorithm, the network model is redesigned by using the lightweight network MobileNetv3-small, which greatly reduces the parameter amount of the model.

The infrared ship target detection model mainly includes three parts: the backbone network, the neck network and the head network.

The backbone network is used to extract image features, and the main function is to transform the original input images into multi-layer feature images. Firstly, the original features are extracted by four-layer convolution layer (CBS, namely Conv2D+BatchNorm+SiLu) is mainly composed of Conv+BN (Batch Normalization)+SiLU. The local spatial information is extracted by convolution operation, and the distribution of eigenvalues is normalized by BN layer, and finally, the nonlinear reform ability is introduced by activation function, so as to realize the reform and extraction of input features. Then the original features are learned through ELAN (Efficient Layer Aggregation Networks) layer, and then the corresponding C3, C4 and C5 outputs are obtained through three MP (MaxPool) layers +ELAN layer, which correspond to the outputs of layers 24, 37 and 50 respectively. ELAN module is an efficient network structure, and ELAN module makes the network learn more features and has stronger robustness by controlling the shortest and longest gradient paths. After 32 times of downsampling, the original image is reduced from 640×640 to 20×20, which is sent to Neck network for feature fusion.

The neck network is a network used to fuse features. Feature fusion is to make the network better learn the features extracted from the backbone network. The features of different granularity are learned separately, combined centrally, and image features are learned as many as possible. Because the size and position of an object in an image are uncertain, a mechanism is needed to deal with objects with different scales and sizes. Feature pyramid is a technology used to deal with multi-scale target detection, which may be realized by adding feature layers with different scales to the backbone network. Finally, the feature images of the top-down part and the down-top part are fused to obtain the final feature image for target detection.

The head network is the part used to perform the target detection of the feature pyramid. YOLOv7 algorithm uses three detection heads to detect and output the predicted category probability, confidence and predicted positioning information of the target object. The detection head outputs three feature scales: 20×20, 40×40 and 80×80. The scales detected by the three scales correspond to large targets, medium targets and small targets respectively.

The specific process of constructing the infrared ship target detection model based on the improved YOLOv7 described in S2 is as follows:
S21, performing the lightweight reform on the original network by using a lightweight feature extraction network, and replacing the backbone feature extraction network of YOLOv7 with the MobileNetv3-small network;
S22, taking the bidirectional feature pyramid network BiFPN as the feature fusion network, the importance of each feature is better judged by adding the concept of feature image weight, and the detection effect of small targets is well enhanced by introducing the residual strategy, and the nodes with low contribution are deleted and the intermediate feature channels are added, thus saving resources and fusing more feature information, and effectively improving the overall performance of the network;
S23, introducing the channel attention mechanism, and obtaining the importance degree of each feature image by learning the feature weights, and giving a weight value to each feature channel according to the importance degree, so that effective information is enhanced and irrelevant information is suppressed, so that the model may achieve better effects; and
S24, optimizing the loss function, namely optimizing the original border regression loss function from CIOU-Loss to Wise-IoU Loss, so as to improve the generalization ability and convergence speed of the model.

The lightweight reform of the backbone network of YOLOv7 algorithm model mentioned in S2 specifically includes:

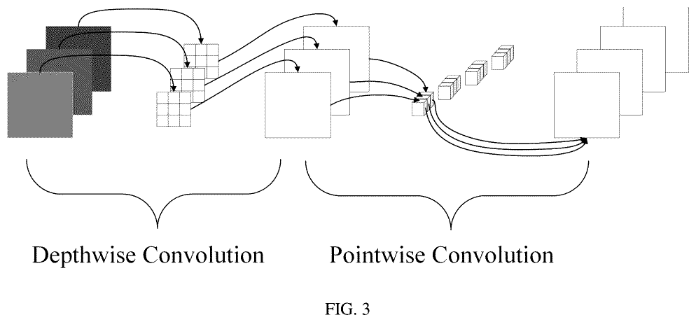

As shown in FIG. 3, MobileNetV3 combines the deep separable convolution and inverted residual structure, deletes the network layer with high computational cost, and integrates into the channel attention mechanism network SENet. In addition, the MobileNetV3 network combines the convolution layer and the batch normalization layer by structural reparameterization method, which is easy to introduce the H_Swish activation function for quantifying the model, which makes the model have the advantages of few parameters and short reasoning time, and makes the network suitable for devices with limited storage space and computing power. Depthwise convolution (DW) and pointwise convolution (PW) are used to extract features from images in the depthwise separable convolution operation. The parameter amount and calculation amount of depthwise separable convolution are

$$\frac{1}{{D}_{K}^{2}} + \frac{1}{N}$$

times that of ordinary convolution. Compared with the conventional convolution operation, parameter amount and calculation cost of the depthwise separable convolution are greatly reduced.

In S2, the improvement of YOLOv7 algorithm model feature fusion network and the introduction of BiFPN specifically include:

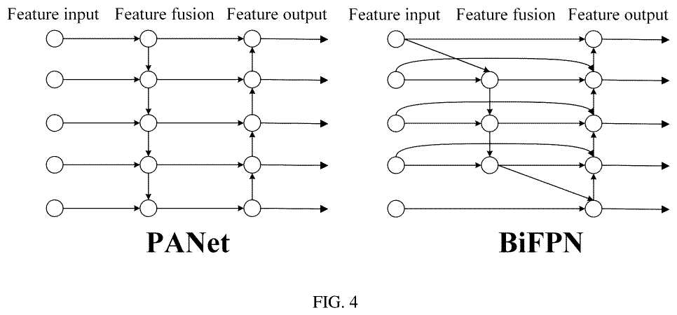

As shown in FIG. 4, bidirectional weighted feature pyramid network (BiFPN) adds jump connection between input and output features in the same layer. Because of the same scale, adding jump connection may better extract and transmit feature information. BiFPN uses weighted feature fusion to fuse input feature layers with different resolutions. The input layers with different resolutions have different weights. By automatically learning the weight parameters of each input layer through the network, the overall feature information may be better represented. The calculation formulas of the two fusion features of BiFPN are as follows:

$${P}_{i}^{td} = Conv ( \frac{{w}_{1} \cdot {P}_{i}^{in} + {w}_{2} \cdot {P}_{i + 1}^{in}}{{w}_{1} + {w}_{2} + ϵ} )$$

$${P}_{i}^{out} = Conv ( \frac{{{w}_{1}}^{′} \cdot {P}_{i}^{in} + {{w}_{2}}^{′} \cdot {P}_{i}^{td} + {{w}_{3}}^{′} \cdot {P}_{i - 1}^{out}}{{{w}_{1}}^{′} + {{w}_{2}}^{′} + {{w}_{3}}^{′} + ϵ} )$$

where Pᵢ^{td} and Pᵢ^{out} represent intermediate transition features of an i-layer on a top-down path and final output features of an i-layer on a down-top path; w₁ and w₂ respectively represent the weight parameters for calculating an input of a current layer and an input of a next layer of the intermediate transition features; w₁′, w₂′ and w₃′ respectively represent a weight of the input of the current layer, a weight of an output of a transition unit of the current layer and a weight of an output of a previous layer, and ∈ value is 0.0001, and Conv stands for a convolution operation on a whole calculation result.

In S2, the introduction of attention mechanism in the improvement of YOLOv7 algorithm model specifically includes:

Attention mechanism may be divided into soft attention mechanism and hard attention mechanism. The soft attention mechanism calculates the weighted average of each input information when transmitting data, and then selectively transmits the input information to the neural network. The hard attention mechanism is to select the most needed data for transmission according to the weight relationship of data. In this embodiment, the SENet structure of soft attention mechanism is selected.

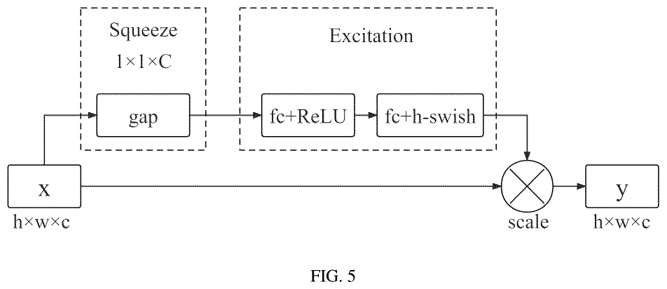

As shown in FIG. 5, SENet may improve the accuracy. The network structure is simple, easy to deploy, and there is no need to introduce new functions and network layers. The network structure uses active learning method to extract the importance of each feature channel, and then gives each feature channel different weights. Based on the weighted parameters, the features in the detection task are filtered, the useful features are highlighted, and the useless features are suppressed, thus improving the speed of feature processing.

SENet network mainly includes three important operations: squeeze, excitation and scaling:

$${F}_{tr} : X \to U , X ∈ {R}^{{H}^{′} \times {W}^{′} \times {C}^{′}} , U ∈ {R}^{H \times W \times C}$$

The process of X→U is mainly used to perform convolution reform on the matrix in X, and after X is convolved with a two-dimensional convolution kernel, U is obtained. The calculation of Fₜᵣ is as follows:

$${u}_{c} = {v}_{c} \times X = {\sum }_{s = 1}^{c} {v}_{c}^{s} \times {x}^{s}$$

Where v_{c} represents the C-th convolution kernel, x^{s} represents the input data, and u_{c} represents the C-th two-dimensional matrix in u, and the size of the feature image is H×W. After Fₜᵣ, the obtained U is a three-dimensional matrix.

The specific process of optimizing the loss function in the improvement of YOLOv7 algorithm model in S2 specifically includes:

The formulas of penalty term are shown in the following formulas:

$${ℒ}_{WIoUv 3} = r {ℒ}_{WIoUv 1} , r = \frac{β}{{δα}^{β - δ}} \\ {ℒ}_{WIoUv 1} = {R}_{WIoU} {ℒ}_{IoU} , β = \frac{{ℒ}_{IoU}^{*}}{\overline{{ℒ}_{IoU}}} ∈ [ 0 , + ∞ ) \\ {R}_{WIoU} = exp ( \frac{{( x - {x}_{gt} )}^{2} + {( y - {y}_{gt} )}^{2}}{{( {W}_{g}^{2} + {H}_{g}^{2} )}^{*}} )$$

where β is an outlier degree to describe a quality of an anchor frame, and small outlier degree means high quality of anchor frame; r is a nonmonotonic focusing coefficient, which makes Wise-IoU gradient gain allocation strategy optimal at every time. Two superparameters, α and δ, are applicable to different models and data sets. R_{WIoU} is the penalty term of the loss function, and the value range is [1, e), [symbol] _{IoU} is the overlap loss between the prediction frame and the anchor frame, and the value range is [0,1]; (x,y) are center coordinates of the prediction frame, and (x_{gt}, y_{gt}) are center coordinates of a real frame; (W_{g}, H_{g}) are a width and a height of a minimum bounding rectangle of the real frame and the prediction frame; and * represents separating (W_{g}, H_{g}) from a current calculation diagram.

The specific process of model training and verifying in S3 is as follows:
S31, setting training parameters, and performing the training by using a random optimization algorithm Adam, where the training batch=16, the momentum is 0.9, the learning rate is initially set to Ir=0.001, and the training iterations Epoch=200;
S32, adaptively scaling the image size, namely, adaptively scaling the images of the training set and the verification set according to the input image size set by the network; and
S33, according to the average accuracy change and loss change trend of cross-validation between the training set and the validation set, adjusting the learning rate and iterations until the accuracy change and loss change gradually become stable, and determining the final learning rate and iterations.

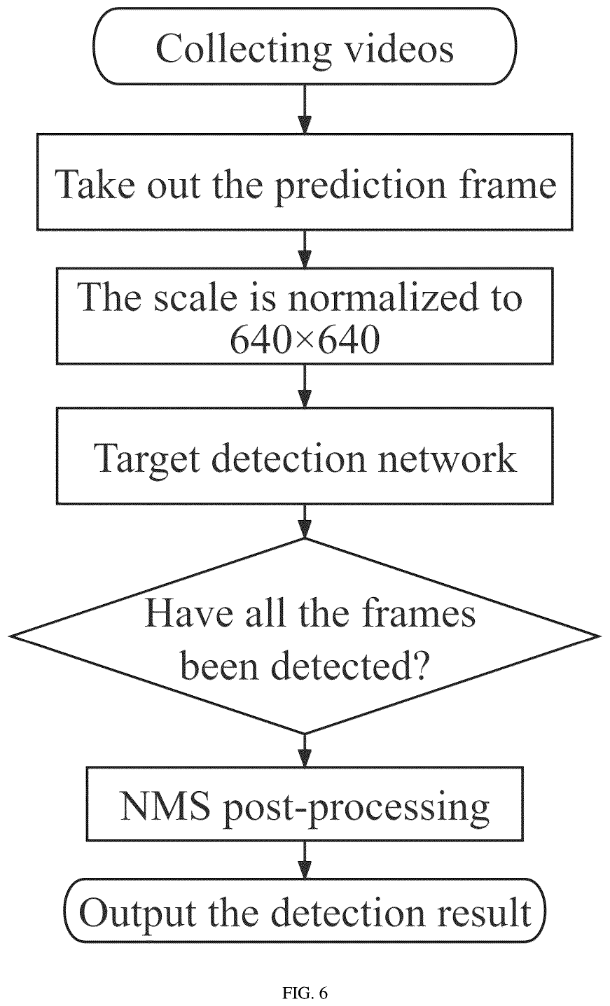

FIG. 6 is the real-time detection flow of the method in this embodiment. First, the current frame to be detected is taken out from the collected video, and the scale of the frame to be detected is scaled to 640×640 pixels, and then the frame is input into the infrared image ship target detection network in this embodiment. Finally, the result is post-processed by the non-maximum suppression algorithm to obtain the final detection result.

This embodiment provides an efficient and accurate infrared image ship target detection method, which may efficiently and accurately detect ships in real time. This embodiment takes the latest method YOLOv7 as a benchmark, and improves the model performance on this benchmark. The final experimental results show that the accuracy of ship recognition reaches 93.5%, and the average recognition speed is 200 frames/s, which meets the requirements of real-time detection of ship targets and may detect ships efficiently and accurately in real time.

In this embodiment, the backbone feature extraction network of YOLOv7 is replaced by MobileNetV3-Small network with less parameter amount, thus realizing the lightweight reform of the model; in the feature fusion stage, attention mechanism is introduced to suppress noise and interference to improve the feature extraction ability of the network, and bidirectional weighted feature pyramid is adopted to improve the feature fusion ability. The loss function of the detection network is optimized from CIOU-Loss to Wise-IoU Loss, and the quality of the anchor frame is evaluated, which further optimizes the regression loss of the bounding box. Through the above reform of the model, the model parameters are reduced by about 38.4%, the number of floating-point operations per second is reduced by about 65.5%, and the model parameter amount and calculation amount are greatly reduced, so that the weight file size obtained after training is 45% smaller than that before lightweight improvement, and it is easy to deploy on the platform with micro-computing power and low power consumption.

YOLOv7 is selected as the benchmark in this embodiment because YOLOv7 is superior to the previous network structures such as YOLOv3 and YOLOv5 in speed and accuracy, and has the following advantages compared with the previous network structures such as YOLOv3 and YOLOv5: 1. YOLOv7 introduces the RepVGG module, which is a new convolutional neural network structure. It may use a complex multi-branch structure in training and a simple single one in deployment; 2. YOLOv7 adopts ELAN module, which is a feature enhancement module based on attention mechanism, and may adaptively adjust the importance of different positions and channels in the feature image, thus improving the feature expression ability; 3. YOLOv7 uses SPPCSP module, which is a combination of spatial pyramid pooling (SPP) and cross-stage partial (CSP) connection, which may increase the receptive field and multi-scale information of feature image, thus improving the robustness of target detection; 4. YOLOv7 also uses PAFPN (Path Aggregation Feature Pyramid Network) module, which is an improved feature pyramid network (FPN). It may fuse features from top-down and down-top, thus improving the performance of small target detection. Therefore, YOLOv7 is a more advanced and efficient target detection network structure.

The network structure involved in this embodiment also shows great advantages in the subsequent model deployment. From the perspective of cost, this embodiment may deploy the deep learning algorithm to the development board with ridiculously low performance from the perspective of lightweight, which may save a large part of the cost for hardware companies. From the perspective of algorithm, this embodiment involves calculation diagram optimization, operator acceleration, operator fusion, and the involved network structure may be well compatible with multiple reasoning architectures. In the model construction stage, the lightweight network MobileNet-V3 is used as the feature extraction network in YOLOv7 network structure, and Lightweight reform is performed on the model to reduce the model parameter amount. In the feature fusion stage, bidirectional weighted feature pyramid architecture is adopted to realize multi-scale feature fusion more efficiently and quickly; meanwhile, attention mechanism is introduced to suppress useless information and improve the accuracy of the model; in the detection stage, the Wise-IoU loss function is introduced to accelerate the network convergence, which may meet the requirements of real-time detection of ship targets and may detect ships efficiently and accurately in real time.

It is necessary to improve the four aspects of this embodiment, because the four aspects jointly improve the efficiency and accuracy of target detection. Specifically:

The backbone network is replaced by MobileNetV3: MobileNetV3 is a convolutional neural network optimized for mobile devices, which achieves a balance between speed and accuracy by combining hardware awareness network architecture search and novel module design. Compared with other backbone networks, MobileNetV3 has smaller parameter amount and calculation amount, while maintaining high classification performance. Therefore, using MobileNetV3 as the backbone network may improve the speed and robustness of target detection.

The feature fusion network is replaced by BiFPN: BiFPN is a bidirectional feature pyramid network, which may realize fast and simple multi-scale feature fusion. BiFPN adopts top-down and down-top information flow modes, and meanwhile uses efficient connection mode and weighted normalization fusion mode. BiFPN also uses different levels of feature images to improve the performance of small target detection. Therefore, using BiFPN as a feature fusion network may improve the accuracy and robustness of target detection.

Introducing SE attention mechanism: SE attention mechanism is a method to increase attention mechanism in channel dimension, which may adaptively learn the importance between channels and weight the channels. SE attention mechanism is realized through two steps: squeeze and excitation. The squeeze step compresses the two-dimensional feature of each channel into a real number through global average pooling, which represents the global information of the channel; the excitation step generates the weight value of each channel through two fully connected layers, which represents the importance degree of the channel. Finally, the weighted value is multiplied by the original feature image to obtain the weighted feature image. Therefore, the introduction of SE attention mechanism may improve the channels of feature images that are useful for the current task and inhibit the channels of feature images that are not useful for the current task.

Modifying the loss function to be Wise-IoU: Wise-IoU is a loss function based on IoU, which uses a dynamic nonmonotonic focusing mechanism. Wise-IoU uses outlier degree instead of IoU to evaluate the quality of anchor frames, and provides a wise gradient gain allocation strategy. This strategy may reduce the competitiveness of high-quality anchor frames, and also reduce the harmful gradient caused by low-quality samples. In this way, Wise-IoU may focus on the anchor frame with ordinary quality and improve the overall performance of the detector.

Therefore, it is necessary to improve the four aspects of this embodiment, and they cooperate with each other to form a more advanced and efficient target detection network structure.

### Embodiment 2

This embodiment provides an overall flow diagram of a method for detecting an infrared ship target based on an improved YOLOv7, which specifically includes:

S1, constructing an infrared ship detection training set, a verification set and a test set, randomly making a division according to the ratio of 7:2:1, converting the divided data set in VOC format into a data set in YOLO format, and carrying out the data enhancement preprocessing on the infrared marine ship data set, such as left-right flipping, image zooming and Mosaic image enhancement.

Further, Mosaic image enhancement randomly cuts a selected image and three random images, then splicing them into an image, which is sent to the network for training, thus improving the universality and robustness of the network.

S2, constructing an infrared ship target detection model based on the improved YOLOv7.

The network structure diagram of the infrared ship target detection model in this embodiment is shown in FIG. 2. Ship target detection algorithm not only needs to accurately identify sea targets in various marine environments, but also needs to reduce the model size as much as possible to complete real-time target detection on the embedded platform. In this embodiment, based on the detection principle of YOLOv7 algorithm, the network model is redesigned by using the lightweight network MobileNetv3-small, which greatly reduces the parameter amount of the model.

The infrared ship target detection model mainly includes three parts: the backbone network, the neck network and the head network.

The backbone network is used to extract image features, and the main function is to transform the original input images into multi-layer feature images. Firstly, the original features are extracted by four-layer convolution layer (CBS) is mainly composed of Conv+BN+SiLU. The local spatial information is extracted by convolution operation, and the distribution of eigenvalues is normalized by BN layer, and finally, the nonlinear reform ability is introduced by activation function, so as to realize the reform and extraction of input features. Then the original features are learned through ELAN layer, and then the corresponding C3, C4 and C5 outputs are obtained through three MP layers +ELAN layer, which correspond to the outputs of layers 24, 37 and 50 respectively. ELAN module is an efficient network structure, and ELAN module makes the network learn more features and has stronger robustness by controlling the shortest and longest gradient paths. After 32 times of downsampling, the original image is reduced from 640×640 to 20×20, which is sent to Neck network for feature fusion.

The neck network is a network used to fuse features. Feature fusion is to make the network better learn the features extracted from the backbone network. The features of different granularity are learned separately, combined centrally, and image features are learned as many as possible. Because the size and position of an object in an image are uncertain, a mechanism is needed to deal with objects with different scales and sizes. Feature pyramid is a technology used to deal with multi-scale target detection, which may be realized by adding feature layers with different scales to the backbone network. Finally, the feature images of the top-down part and the down-top part are fused to obtain the final feature image for target detection.

The head network is the part used to perform the target detection of the feature pyramid. YOLOv7 algorithm uses three detection heads to detect and output the predicted category probability, confidence and predicted positioning information of the target object. The detection head outputs three feature scales: 20×20, 40×40 and 80×80. The scales detected by the three scales correspond to large targets, medium targets and small targets respectively.

The specific process of constructing the infrared ship target detection model based on the improved YOLOv7 described in S2 is as follows:
S21, performing the lightweight reform on the original network by using a lightweight feature extraction network, and replacing the backbone feature extraction network of YOLOv7 with the MobileNetv3-small network;
S22, taking the bidirectional feature pyramid network BiFPN as the feature fusion network, the importance of each feature is better judged by adding the concept of feature image weight, and the detection effect of small targets is well enhanced by introducing the residual strategy, and the nodes with low contribution are deleted and the intermediate feature channels are added, thus saving resources and fusing more feature information, and effectively improving the overall performance of the network;
S23, introducing the channel attention mechanism, and obtaining the importance degree of each feature image by learning the feature weights, and giving a weight value to each feature channel according to the importance degree, so that effective information is enhanced and irrelevant information is suppressed, so that the model may achieve better effects; and
S24, optimizing the loss function, namely optimizing the original border regression loss function from CIOU-Loss to Wise-IoU Loss, so as to improve the generalization ability and convergence speed of the model.

The lightweight reform of the backbone network of YOLOv7 algorithm model mentioned in S2 specifically includes:

As shown in FIG. 3, MobileNetV3 combines the deep separable convolution and inverted residual structure, deletes the network layer with high computational cost, and integrates into the channel attention mechanism network SENet. In addition, the MobileNetV3 network combines the convolution layer and the batch normalization layer by structural reparameterization method, which is easy to introduce the H_Swish activation function for quantifying the model, which makes the model have the advantages of few parameters and short reasoning time, and makes the network suitable for devices with limited storage space and computing power. Depthwise convolution (DW) and pointwise convolution (PW) are used to extract features from images in the depthwise separable convolution operation. The parameter amount and calculation amount of depthwise separable convolution are

$$\frac{1}{{D}_{K}^{2}} + \frac{1}{N}$$

times that of ordinary convolution. Compared with the conventional convolution operation, parameter amount and calculation cost of the depthwise separable convolution are greatly reduced.

In S2, the improvement of YOLOv7 algorithm model feature fusion network and the introduction of BiFPN specifically include:

As shown in FIG. 4, bidirectional weighted feature pyramid network (BiFPN) adds jump connection between input and output features in the same layer. Because of the same scale, adding jump connection may better extract and transmit feature information. BiFPN uses weighted feature fusion to fuse input feature layers with different resolutions. The input layers with different resolutions have different weights. By automatically learning the weight parameters of each input layer through the network, the overall feature information may be better represented. The calculation formulas of the two fusion features of BiFPN are as follows:

$${P}_{i}^{td} = Conv ( \frac{{w}_{1} \cdot {P}_{i}^{in} + {w}_{2} \cdot {P}_{i + 1}^{in}}{{w}_{1} + {w}_{2} + ϵ} ) \\ {P}_{i}^{out} = Conv ( \frac{{w}_{1}^{′} \cdot {P}_{i}^{in} + {w}_{2}^{′} \cdot {P}_{i}^{td} + {w}_{3}^{′} \cdot {P}_{i - 1}^{out}}{{w}_{1}^{′} + {w}_{2}^{′} + {w}_{3}^{′} + ϵ} )$$

where Pᵢ^{td} and Pᵢ^{out} represent intermediate transition features of an i-layer on a top-down path and final output features of an i-layer on a down-top path; w₁ and w₂ respectively represent the weight parameters for calculating an input of a current layer and an input of a next layer of the intermediate transition features; w₁′, w₂′ and w₃′ respectively represent a weight of the input of the current layer, a weight of an output of a transition unit of the current layer and a weight of an output of a previous layer, and ∈ value is 0.0001, and Conv stands for a convolution operation on a whole calculation result.

In S2, the introduction of attention mechanism in the improvement of YOLOv7 algorithm model specifically includes:

Attention mechanism may be divided into soft attention mechanism and hard attention mechanism. The soft attention mechanism calculates the weighted average of each input information when transmitting data, and then selectively transmits the input information to the neural network. The hard attention mechanism is to select the most needed data for transmission according to the weight relationship of data. In this embodiment, the SENet structure of soft attention mechanism is selected.

As shown in FIG. 5, SENet may improve the accuracy. The network structure is simple, easy to deploy, and there is no need to introduce new functions and network layers. The network structure uses active learning method to extract the importance of each feature channel, and then gives each feature channel different weights. Based on the weighted parameters, the features in the detection task are filtered, the useful features are highlighted, and the useless features are suppressed, thus improving the speed of feature processing.

SENet network mainly includes three important operations: squeeze, excitation and scaling:

$${F}_{tr} : X \to U , X ∈ {R}^{{H}^{′} \times {W}^{′} \times {C}^{′}} , U ∈ {R}^{H \times W \times C}$$

The process of X→U is mainly used to perform convolution reform on the matrix in X, and after X is convolved with a two-dimensional convolution kernel, U is obtained. The calculation of Fₜᵣ is as follows:

$${u}_{c} = {v}_{c} \times X = {\sum }_{s = 1}^{c} {v}_{c}^{s} \times {x}^{s}$$

where v_{c} represents the C-th convolution kernel, x^{s} represents the input data, and u_{c} represents the C-th two-dimensional matrix in u, and the size of the feature image is H×W. After Fₜᵣ, the obtained U is a three-dimensional matrix.

The specific process of optimizing the loss function in the improvement of YOLOv7 algorithm model in S2 specifically includes:

The formulas of penalty term are shown in the following formulas:

$${ℒ}_{WIoUv 3} = r {ℒ}_{WIoUv 1} , r = \frac{β}{{δα}^{β - δ}} \\ {ℒ}_{WIoUv 1} = {R}_{WIoU} {ℒ}_{IoU} , β = \frac{{ℒ}_{IoU}^{*}}{\overline{{ℒ}_{IoU}}} ∈ [ 0 , + ∞ ) \\ {R}_{WIoU} = exp ( \frac{{( x - {x}_{gt} )}^{2} + {( y - {y}_{gt} )}^{2}}{{( {W}_{g}^{2} + {H}_{g}^{2} )}^{*}} )$$

where β is an outlier degree to describe a quality of an anchor frame, and small outlier degree means high quality of anchor frame; r is a nonmonotonic focusing coefficient, which makes Wise-IoU gradient gain allocation strategy optimal at every time. Two superparameters, α and δ, are applicable to different models and data sets. R_{WIoU} is the penalty term of the loss function, and the value range is [1, e), [symbol] _{IoU} is the overlap loss between the prediction frame and the anchor frame, and the value range is [0,1]; (x,y) are center coordinates of the prediction frame, and (x_{gt}, y_{gt}) are center coordinates of a real frame; (W_{g}, H_{g}) are a width and a height of a minimum bounding rectangle of the real frame and the prediction frame; and * represents separating (W_{g}, H_{g}) from a current calculation diagram.

S3, model training and verifying: training the YOLOv7 model improved by S2, optimizing the network parameters to obtain the weight file for detection, and performing verifying.

The specific process of model training and verifying in S3 is as follows:
S31, setting training parameters, and performing the training by using a random optimization algorithm Adam, where the training batch=16, the momentum is 0.9, the learning rate is initially set to Ir=0.001, and the training iterations Epoch=200;
S32, adaptively scaling the image size, namely, adaptively scaling the images of the training set and the verification set according to the input image size set by the network; and
S33, according to the average accuracy change and loss change trend of cross-validation between the training set and the validation set, adjusting the learning rate and iterations until the accuracy change and loss change gradually become stable, and determining the final learning rate and iterations.

S4, model test: sending the test set to the model trained in S3 to test the performance of infrared image ship target detection model based on improved YOLOv7.

S5, model evaluation: according to the test results of S4, evaluating the infrared ship target detection model based on improved YOLOv7 trained by S3 with mAP and FPS as evaluation indexes.

FIG. 6 is the real-time detection flow of the method in this embodiment. First, the current frame to be detected is taken out from the collected video, and the scale of the frame to be detected is scaled to 640×640 pixels, and then the frame is input into the infrared image ship target detection network in this embodiment. Finally, the result is post-processed by the non-maximum suppression algorithm to obtain the final detection result.

This embodiment provides an efficient and accurate infrared image ship target detection method, which may efficiently and accurately detect ships in real time. This embodiment takes the latest method YOLOv7 as a benchmark, and improves the model performance on this benchmark. The final experimental results show that the accuracy of ship recognition reaches 93.5%, and the average recognition speed is 200 frames/s, which meets the requirements of real-time detection of ship targets and may detect ships efficiently and accurately in real time.

In this embodiment, the backbone feature extraction network of YOLOv7 is replaced by MobileNetV3-Small network with less parameter amount, thus realizing the lightweight reform of the model; in the feature fusion stage, attention mechanism is introduced to suppress noise and interference to improve the feature extraction ability of the network, and bidirectional weighted feature pyramid is adopted to improve the feature fusion ability. The loss function of the detection network is optimized from CIOU-Loss to Wise-IoU Loss, and the quality of the anchor frame is evaluated, which further optimizes the regression loss of the bounding box. Through the above reform of the model, the model parameters are reduced by about 38.4%, the number of floating-point operations per second is reduced by about 65.5%, and the model parameter amount and calculation amount are greatly reduced, so that the weight file size obtained after training is 45% smaller than that before lightweight improvement, and it is easy to deploy on the platform with micro-computing power and low power consumption.

### Embodiment 3

This embodiment provides an overall flow diagram of a method for detecting an infrared ship target based on an improved YOLOv7, which specifically includes:

S1, constructing an infrared ship detection training set, a verification set and a test set, randomly making a division according to the ratio of 7:2:1, converting the divided data set in VOC format into a data set in YOLO format, and carrying out the data enhancement preprocessing on the infrared marine ship data set, such as left-right flipping, image zooming and Mosaic image enhancement.

Further, Mosaic image enhancement randomly cuts a selected image and three random images, then splicing them into an image, which is sent to the network for training, thus improving the universality and robustness of the network.

S2, constructing an infrared ship target detection model based on the improved YOLOv7.

The network structure diagram of the infrared ship target detection model in this embodiment is shown in FIG. 2. Ship target detection algorithm not only needs to accurately identify sea targets in various marine environments, but also needs to reduce the model size as much as possible to complete real-time target detection on the embedded platform. In this embodiment, based on the detection principle of YOLOv7 algorithm, the network model is redesigned by using the lightweight network MobileNetv3-small, which greatly reduces the parameter amount of the model.

The infrared ship target detection model mainly includes three parts: the backbone network, the neck network and the head network.

The backbone network is used to ex tract image features, and the main function is to transform the original input images into multi-layer feature images. Firstly, the original features are extracted by four-layer convolution layer (CBS), CBS is mainly composed of Conv+BN+SiLU. The local spatial information is extracted by convolution operation, and the distribution of eigenvalues is normalized by BN layer, and finally, the nonlinear reform ability is introduced by activation function, so as to realize the reform and extraction of input features. Then the original features are learned through ELAN layer, and then the corresponding C3, C4 and C5 outputs are obtained through three MP layers +ELAN layer, which correspond to the outputs of layers 24, 37 and 50 respectively. ELAN module is an efficient network structure, and ELAN module makes the network learn more features and has stronger robustness by controlling the shortest and longest gradient paths. After 32 times of downsampling, the original image is reduced from 640×640 to 20×20, which is sent to Neck network for feature fusion.

The neck network is a network used to fuse features. Feature fusion is to make the network better learn the features extracted from the backbone network. The features of different granularity are learned separately, combined centrally, and image features are learned as many as possible. Because the size and position of an object in an image are uncertain, a mechanism is needed to deal with objects with different scales and sizes. Feature pyramid is a technology used to deal with multi-scale target detection, which may be realized by adding feature layers with different scales to the backbone network. Finally, the feature images of the top-down part and the down-top part are fused to obtain the final feature image for target detection.

The head network is the part used to perform the target detection of the feature pyramid. YOLOv7 algorithm uses three detection heads to detect and output the predicted category probability, confidence and predicted positioning information of the target object. The detection head outputs three feature scales: 20×20, 40×40 and 80×80. The scales detected by the three scales correspond to large targets, medium targets and small targets respectively.

The specific process of constructing the infrared ship target detection model based on the improved YOLOv7 described in S2 is as follows:

S21, performing the lightweight reform on the original network by using a lightweight feature extraction network, and replacing the backbone feature extraction network of YOLOv7 with the MobileNetv3-small network, specifically including:

As shown in FIG. 3, MobileNetV3 combines the deep separable convolution and inverted residual structure, deletes the network layer with high computational cost, and integrates into the channel attention mechanism network SENet. In addition, the MobileNetV3 network combines the convolution layer and the batch normalization layer by structural reparameterization method, which is easy to introduce the H_Swish activation function for quantifying the model, which makes the model have the advantages of few parameters and short reasoning time, and makes the network suitable for devices with limited storage space and computing power. Depthwise convolution (DW) and pointwise convolution (PW) are used to extract features from images in the depthwise separable convolution operation. The parameter amount and calculation amount of depthwise separable convolution are

$$\frac{1}{{D}_{K}^{2}} + \frac{1}{N}$$

times that of ordinary convolution. Compared with the conventional convolution operation, parameter amount and calculation cost of the depthwise separable convolution are greatly reduced.

S22, taking the bidirectional feature pyramid network BiFPN as the feature fusion network, the importance of each feature is better judged by adding the concept of feature image weight, and the detection effect of small targets is well enhanced by introducing the residual strategy, and the nodes with low contribution are deleted and the intermediate feature channels are added, thus saving resources and fusing more feature information, and effectively improving the overall performance of the network. The specific improvements include:

As shown in FIG. 4, bidirectional weighted feature pyramid network (BiFPN) adds jump connection between input and output features in the same layer. Because of the same scale, adding jump connection may better extract and transmit feature information. BiFPN uses weighted feature fusion to fuse input feature layers with different resolutions. The input layers with different resolutions have different weights. By automatically learning the weight parameters of each input layer through the network, the overall feature information may be better represented. The calculation formulas of the two fusion features of BiFPN are as follows:

$${P}_{i}^{td} = Conv ( \frac{{w}_{1} \cdot {P}_{i}^{in} + {w}_{2} \cdot {P}_{i + 1}^{in}}{{w}_{1} + {w}_{2} + ϵ} ) \\ {P}_{i}^{out} = Conv ( \frac{{w}_{1}^{′} \cdot {P}_{i}^{in} + {w}_{2}^{′} \cdot {P}_{i}^{td} + {w}_{3}^{′} \cdot {P}_{i - 1}^{out}}{{w}_{1}^{′} + {w}_{2}^{′} + {w}_{3}^{′} + ϵ} )$$

where Pᵢ^{td} and Pᵢ^{out} represent intermediate transition features of an i-layer on a top-down path and final output features of an i-layer on a down-top path; w₁ and w₂ respectively represent the weight parameters for calculating an input of a current layer and an input of a next layer of the intermediate transition features; w₁′, w₂′ and w₃′ respectively represent a weight of the input of the current layer, a weight of an output of a transition unit of the current layer and a weight of an output of a previous layer, and ∈ value is 0.0001, and Conv stands for a convolution operation on a whole calculation result.

S23, introducing the channel attention mechanism, and obtaining the importance degree of each feature image by learning the feature weights, and giving a weight value to each feature channel according to the importance degree, so that effective information is enhanced and irrelevant information is suppressed, so that the model may achieve better effects.

In S2, the introduction of attention mechanism in the improvement of YOLOv7 algorithm model specifically includes:

Attention mechanism may be divided into soft attention mechanism and hard attention mechanism. The soft attention mechanism calculates the weighted average of each input information when transmitting data, and then selectively transmits the input information to the neural network. The hard attention mechanism is to select the most needed data for transmission according to the weight relationship of data. In this embodiment, the SENet structure of soft attention mechanism is selected.

As shown in FIG. 5, SENet may improve the accuracy. The network structure is simple, easy to deploy, and there is no need to introduce new functions and network layers. The network structure uses active learning method to extract the importance of each feature channel, and then gives each feature channel different weights. Based on the weighted parameters, the features in the detection task are filtered, the useful features are highlighted, and the useless features are suppressed, thus improving the speed of feature processing.

SENet network mainly includes three important operations: squeeze, excitation and scaling:

$${F}_{tr} : X \to U , X ∈ {R}^{{H}^{′} \times {W}^{′} \times {C}^{′}} , U ∈ {R}^{H \times W \times C}$$

The process of X→U is mainly used to perform convolution reform on the matrix in X, and after X is convolved with a two-dimensional convolution kernel, U is obtained. The calculation of Fₜᵣ is as follows:

$${u}_{c} = {v}_{c} \times X = {\sum }_{s = 1}^{c} {v}_{c}^{s} \times {x}^{s}$$

where v_{c} represents the C-th convolution kernel, x^{s} represents the input data, and u_{c} represents the C-th two-dimensional matrix in u, and the size of the feature image is H×W. After Fₜᵣ, the obtained U is a three-dimensional matrix.

S24, optimizing the loss function, namely optimizing the original border regression loss function from CIOU-Loss to Wise-IoU Loss, so as to improve the generalization ability and convergence speed of the model. The specific process of optimizing the loss function includes:

The formulas of penalty term are shown in the following formulas:

$${ℒ}_{WIoUv 3} = r {ℒ}_{WIoUv 1} , r = \frac{β}{{δα}^{β - δ}} \\ {ℒ}_{WIoUv 1} = {R}_{WIoU} {ℒ}_{IoU} , β = \frac{{ℒ}_{IoU}^{*}}{\overline{{ℒ}_{IoU}}} ∈ [ 0 , + ∞ ) \\ {R}_{WIoU} = exp ( \frac{{( x - {x}_{gt} )}^{2} + {( y - {y}_{gt} )}^{2}}{{( {W}_{g}^{2} + {H}_{g}^{2} )}^{*}} )$$

where, β is an outlier degree to describe a quality of an anchor frame, and small outlier degree means high quality of anchor frame; r is a nonmonotonic focusing coefficient, which makes Wise-IoU gradient gain allocation strategy optimal at every time. Two superparameters, α and δ, are applicable to different models and data sets. R_{WIoU} is the penalty term of the loss function, and the value range is [1, e), [symbol] _{IoU} is the overlap loss between the prediction frame and the anchor frame, and the value range is [0,1]; (x,y) are center coordinates of the prediction frame, and (x_{gt}, y_{gt}) are center coordinates of a real frame; (W_{g}, H_{g}) are a width and a height of a minimum bounding rectangle of the real frame and the prediction frame; and * represents separating (W_{g}, H_{g}) from a current calculation diagram.

S3, model training and verifying: training the YOLOv7 model improved by S2, optimizing the network parameters to obtain the weight file for detection, and performing verifying.

The specific process of model training and verifying in S3 is as follows:
S31, setting training parameters, and performing the training by using a random optimization algorithm Adam, where the training batch=16, the momentum is 0.9, the learning rate is initially set to Ir=0.001, and the training iterations Epoch=200;
S32, adaptively scaling the image size, namely, adaptively scaling the images of the training set and the verification set according to the input image size set by the network; and
S33, according to the average accuracy change and loss change trend of cross-validation between the training set and the validation set, adjusting the learning rate and iterations until the accuracy change and loss change gradually become stable, and determining the final learning rate and iterations.

S4, model test: sending the test set to the model trained in S3 to test the performance of infrared image ship target detection model based on improved YOLOv7.

S5, model evaluation: according to the test results of S4, evaluating the infrared ship target detection model based on improved YOLOv7 trained by S3 with mAP and FPS as evaluation indexes.

S6, using the infrared ship target detection model based on the improved YOLOv7 trained in S3 to detect ship targets in infrared images or infrared video streams.

FIG. 6 is the real-time detection flow of the method in this embodiment. First, the current frame to be detected is taken out from the collected video, and the scale of the frame to be detected is scaled to 640×640 pixels, and then the frame is input into the infrared image ship target detection network in this embodiment. Finally, the result is post-processed by the non-maximum suppression algorithm to obtain the final detection result.

This embodiment provides an efficient and accurate infrared image ship target detection method, which may efficiently and accurately detect ships in real time. This embodiment takes the latest method YOLOv7 as a benchmark, and improves the model performance on this benchmark. The final experimental results show that the accuracy of ship recognition reaches 93.5%, and the average recognition speed is 200 frames/s, which meets the requirements of real-time detection of ship targets and may detect ships efficiently and accurately in real time.

In this embodiment, the backbone feature extraction network of YOLOv7 is replaced by MobileNetV3-Small network with less parameter amount, thus realizing the lightweight reform of the model; in the feature fusion stage, attention mechanism is introduced to suppress noise and interference to improve the feature extraction ability of the network, and bidirectional weighted feature pyramid is adopted to improve the feature fusion ability. The loss function of the detection network is optimized from CIOU-Loss to Wise-IoU Loss, and the quality of the anchor frame is evaluated, which further optimizes the regression loss of the bounding box. Through the above reform of the model, the model parameters are reduced by about 38.4%, the number of floating-point operations per second is reduced by about 65.5%, and the model parameter amount and calculation amount are greatly reduced, so that the weight file size obtained after training is 45% smaller than that before lightweight improvement, and it is easy to deploy on the platform with micro-computing power and low power consumption.

The above is only the preferred embodiment of this application, but the protection scope of this application is not limited to this. Any change or replacement that may be easily thought of by a person familiar with this technical field within the technical scope disclosed in this application should be covered by this application. Therefore, the protection scope of this application should be based on the protection scope of the claims.

What is claimed is:

1. A method for detecting an infrared ship target based on an improved YOLOv7 (You Only Look Once version 7), comprising following steps:
obtaining an infrared maritime ship data set;
reforming a YOLOv7 network structure based on an MobileNetv3 network and a bidirectional weighted feature pyramid network, and obtaining an infrared ship target detection model by introducing an attention mechanism and an optimized loss function;
training and verifying the infrared ship target detection model based on the infrared maritime ship data set to obtain the infrared ship target detection model trained; and
detecting a maritime ship based on the infrared ship target detection model trained.

2. The method for detecting an infrared ship target based on an improved YOLOv7 according to claim 1, wherein
after obtaining the infrared maritime ship data set, further comprising: carrying out a data enhancement processing on the infrared maritime ship data set, and then dividing the infrared maritime ship data set processed into a training set, a verification set and a test set based on a preset ratio.

3. The method for detecting an infrared ship target based on an improved YOLOv7 according to claim 1, wherein
a process of reforming the YOLOv7 network structure based on the MobileNetv3 network and the bidirectional weighted feature pyramid network comprises: replacing a backbone feature extraction network in the YOLOv7 network structure with the MobileNetv3 network, and replacing a feature fusion network in the YOLOv7 network structure with the bidirectional weighted feature pyramid network.

4. The method for detecting an infrared ship target based on an improved YOLOv7 according to claim 3, wherein
the MobileNetv3 network combines a depthwise separable convolution structure and an inverted residual structure, and is integrated into a channel attention mechanism network; wherein, the depthwise separable convolution structure comprises a depthwise convolution and a pointwise convolution.

5. The method for detecting an infrared ship target based on an improved YOLOv7 according to claim 3, wherein
the bidirectional weighted feature pyramid network increases a feature image weight, introduces a residual strategy, deletes nodes with low contribution, and adds a intermediate feature channel.

6. The method for detecting an infrared ship target based on an improved YOLOv7 according to claim 5, wherein
a process of increasing the feature image weight comprises: the bidirectional weighted feature pyramid network automatically learns weight parameters of each input feature layer, and then performs a weighted feature fusion on the input feature layer with different resolutions and corresponding weight parameters and performs an output; wherein the bidirectional weighted feature pyramid network adds a jump connection between the input feature layer and an output feature layer in a same layer.

7. The method for detecting an infrared ship target based on an improved YOLOv7 according to claim 6, wherein
calculation formulas of the weighted feature fusion is as follows:
$${P}_{i}^{td} = Conv ( \frac{{w}_{1} \cdot {P}_{i}^{in} + {w}_{2} \cdot {P}_{i + 1}^{in}}{{w}_{1} + {w}_{2} + ϵ} ) \\ {P}_{i}^{out} = Conv ( \frac{{w}_{1}^{′} \cdot {P}_{i}^{in} + {w}_{2}^{′} \cdot {P}_{i}^{td} + {w}_{3}^{′} \cdot {P}_{i - 1}^{out}}{{w}_{1}^{′} + {w}_{2}^{′} + {w}_{3}^{′} + ϵ} )$$
wherein Pᵢ^{td} and Pᵢ^{out} represent intermediate transition features of an i-layer on a top-down path and final output features of an i-layer on a down-top path; w₁ and w₂ respectively represent the weight parameters for calculating an input of a current layer and an input of a next layer of the intermediate transition features; w₁′, w₂′ and w₃′ respectively represent a weight of the input of the current layer, a weight of an output of a transition unit of the current layer and a weight of an output of a previous layer, and ∈ value is 0.0001, and Conv stands for a convolution operation on a whole calculation result.

8. The method for detecting an infrared ship target based on an improved YOLOv7 according to claim 1, wherein
the attention mechanism is an SENet (Squeeze-and-Excitation Networks) structure with a soft attention mechanism, and the SENet structure is used to extract importance degree of each feature channel by an active learning method, then give the each feature channel different weights, and finally perform a filtration processing for features in a detection task based on a weight of the each feature channel.

9. The method for detecting an infrared ship target based on an improved YOLOv7 according to claim 1, wherein
the optimized loss function is shown in following formulas:
$${ℒ}_{WIoUv 3} = r {ℒ}_{WIoUv 1} , r = \frac{β}{{δα}^{β - δ}} \\ {ℒ}_{WIoUv 1} = {R}_{WIoU} {ℒ}_{IoU} , β = \frac{{ℒ}_{IoU}^{*}}{\overline{{ℒ}_{IoU}}} ∈ [ 0 , + ∞ ) \\ {R}_{WIoU} = exp ( \frac{{( x - {x}_{gt} )}^{2} + {( y - {y}_{gt} )}^{2}}{{( {W}_{g}^{2} + {H}_{g}^{2} )}^{*}} )$$
wherein β is an outlier degree to describe a quality of an anchor frame; r is a nonmonotonic focusing coefficient, α and δ are hyperparameters; R_{WIoU} is a penalty term of a loss function; [symbol] _{IoU} is an overlap loss between a prediction frame and the anchor frame; (x,y) are center coordinates of the prediction frame, and (x_{gt}, y_{gt}) are center coordinates of a real frame; (W_{g}, H_{g}) are a width and a height of a minimum bounding rectangle of the real frame and the prediction frame; and * represents separating (W_{g}, H_{g}) from a current calculation diagram.

10. The method for detecting an infrared ship target based on an improved YOLOv7 according to claim 2, wherein
a process of training and verifying the infrared ship target detection model comprises: setting an initial learning rate and initial iterations of the infrared ship target detection model, and adaptively adjusting a scaling of the training set, verification set and test set based on a preset input image size; cross-verifying an average accuracy change and loss change trend of the infrared ship target detection model based on the training set and the verification set after an adjusting, and adjusting the initial learning rate and the initial iterations until the average accuracy change and loss change tend to be stable, so as to obtain a target learning rate and target iterations, and further obtain the infrared ship target detection model trained; finally, testing the infrared ship target detection model trained based on the test set after the adjusting.
